(19) United States
(12) Patent Application Publication
(10) Pub. No.: US 2008/0210661 A1
(43) Pub. Date: Sep. 4, 2008

(54) Method For Forming Via Hole in Substrate For Flexible Printed Circuit Board

(76) Inventors: Kazuo Satoh, Tokyo (JP); Hideo Yamazaki, Tokyo (JP)

Correspondence Address: 3M INNOVATIVE PROPERTIES COMPANY, PO BOX 33427, ST. PAUL, MN, 55133-3427, US

(21) Appl. No.: 11/915,228

(22) PCT Filed: May 23, 2006
(86) PCT No.: PCT/US2006/019940

§ 371 Date: Nov. 21, 2007

(30) Foreign Application Priority Data
May 26, 2005 (JP) 2005-153525

(51) Int. Cl. H01B 13/00

(52) U.S. Cl. 216/17

(57) ABSTRACT

There is provided a method for forming a via hole (2) in a substrate (10) for a flexible printed circuit board, the method being capable of simply forming a via hole having an excellent circularness of an opening portion and high reliability. In a method for forming a via hole in a substrate for a flexible printed circuit board, the method includes the steps: forming a first thin film layer (11) containing metal or alloy and having a thickness of less than 2 μm on one surface (15) of a substrate, disposing a second thin film layer (12) over the first thin film layer (11), selectively removing a portion, corresponding to a region where the via hole (2) is formed, of the second thin film layer (12), etching the first thin film layer (11), and subjecting the substrate (10) to chemical milling to form the via hole (2).

### BACKGROUND

The present invention relates to a method for forming a via hole in a substrate for a flexible printed circuit board. More particularly, the present invention relates to a method for forming a via hole in a substrate for a flexible printed circuit board, the method being capable of simply forming a via hole having an excellent circularness of an opening portion and high reliability.

There has recently been employed a flexible printed circuit board having a printed circuit having two or more layers as a circuit board capable of high density mounting of electronic parts (ex. JP-A-2004-528725). In the flexible printed circuit board, a printed circuit is disposed on a polymer-containing sheet-shaped substrate.

In such a substrate for a flexible printed circuit board is typically formed a via hole extending from one surface to the other surface of the material. The via hole is typically filled with a conductive substance such as solder to ensure mutual electrical connection between two or more layers of a print circuit.

As a conventional method for forming a via hole in a substrate for a flexible printed circuit board, for example, a metal leaf such as a copper leaf is disposed on one surface of a substrate for a flexible printed circuit board in the first place, and then, a portion, corresponding to a region where a via hole is formed, is removed by etching to make it a resist mask. As a method for etching the metal leaf, there may be employed a method where a resin thin film such as a photosensitive dry film is disposed on a surface of the metal leaf, a predetermined region of the resin thin film is exposed or developed to make it a mask, the substrate is immersed in a known etching agent such as a solution of cupric chloride to etch the exposed portion of the copperleaf. As a metal leaf for forming a mask is generally employed a copper leaf having a thickness of 8 to 18 μm. After the resist mask is formed in such a manner, a region having no resist mask, i.e., a region where a via hole is formed, is subjected to etching by, for example, irradiating a laser beam such as a UV laser beam or an electron beam to form a via hole extending in the thickness direction of a sheet-shaped substrate for a flexible printed circuit board.

### SUMMARY

However, when a via hole is formed by the aforementioned conventional method for forming a via hole in a substrate for a flexible print circuit board, there arises a problem of having an oval opening portion. When an opening portion of a via hole is oval, it is difficult to reduce a pitch of the via hole and to minimize a diameter of the via hole in accordance with densification of a circuit. In addition, a ball pitch of solder balls may have deviation, or when solder balls each disposed in each via hole are melted, adjacent balls may contact each other to have a defect.

The present invention has been made to solve the above problems and aims to provide a method for forming a via hole in a substrate for a flexible printed circuit board, the method being capable of simply forming a via hole having an excellent circularness of an opening portion and high reliability.

According to the present invention, there is provided a method for forming a via hole in a polymer-containing sheet-shaped substrate for a flexible printed circuit board, the via hole extending in a thickness direction of the substrate for the flexible printed circuit board,

wherein the method comprises:

forming a first thin film layer containing metal or alloy and having a thickness of less than 2 μm on one surface of the substrate for the flexible printed circuit board to obtain a substrate with the first thin film layer,

disposing a second thin film layer containing a photosetting or thermosetting resin in such a manner that it covers the first thin film layer of the substrate with the first thin film layer to obtain a substrate with the second thin film layer,

selectively removing the second thin film layer from a portion corresponding to a region where a via hole is to be formed in the substrate to make the second thin film layer a second resist mask,

etching the first thin film layer through the second resist mask to make the first thin film layer a first resist mask to obtain a substrate with the resist masks where the first and the second resist masks are disposed on the substrate for the flexible printed circuit board, and

subjecting the substrate with the resist masks to chemical milling to form the via hole extending in a thickness direction of the substrate for the flexible printed circuit board.

In the present invention, it is preferable that a circuit of a conductive material is formed on the other surface of the substrate for the flexible printed circuit board.

In the present invention, “etching” means to remove metal or alloy from a desired portion using an acid or an alkali solution. In addition, “chemical milling” means to remove a desired portion by hydrolyzing a substrate for a flexible print circuit board with chemical liquid, for example, an alkali solution and a hydrazine solution.

According to a method for forming a via hole in a substrate for a flexible printed circuit board of the present invention, a via hole having an excellent circularness of an opening portion and high reliability can simply be formed.

### DESCRIPTION OF THE DRAWINGS

FIG. 1 is a plan view schematically showing via holes formed according to an embodiment of a method for forming a via hole in a substrate for a flexible printed circuit board of the present invention.

FIG. 2(a) is an explanatory view schematically showing a part of an embodiment of a method for forming a via hole in a substrate for a flexible printed circuit board of the present invention.

FIG. 2(b) is an explanatory view schematically showing a part of an embodiment of a method for forming a via hole in a substrate for a flexible printed circuit board of the present invention.

FIG. 2(c) is an explanatory view schematically showing a part of an embodiment of a method for forming a via hole in a substrate for a flexible printed circuit board of the present invention.

FIG. 2(d) is an explanatory view schematically showing a part of an embodiment of a method for forming a via hole in a substrate for a flexible printed circuit board of the present invention.

FIG. 2(e) is an explanatory view schematically showing a part of an embodiment of a method for forming a via hole in a substrate for a flexible printed circuit board of the present invention.

FIG. 2(f) is an explanatory view schematically showing a part of an embodiment of a method for forming a via hole in a substrate for a flexible printed circuit board of the present invention.

FIG. 2(g) is an explanatory view schematically showing a part of an embodiment of a method for forming a via hole in a substrate for a flexible printed circuit board of the present invention.

### DETAILED DESCRIPTION

The present invention is hereinbelow described on the basis of embodiments with referring to drawings. However, the present invention is not limited to the following embodiments, and it should be understood that modification, improvement, or the like, may suitably be added to the design on the basis of general knowledge of a person of ordinary skill within the range of not deviating from the gist of the present invention.

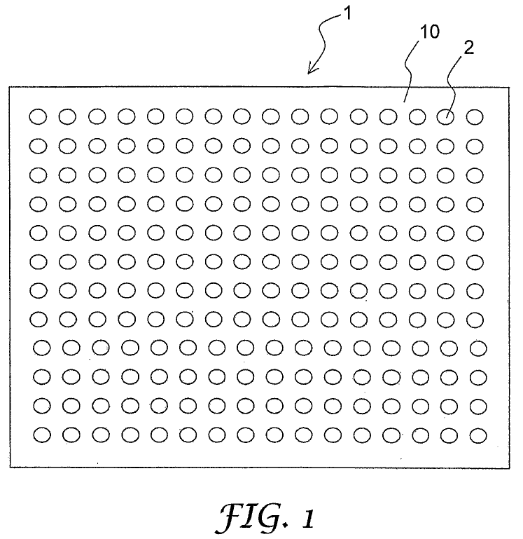

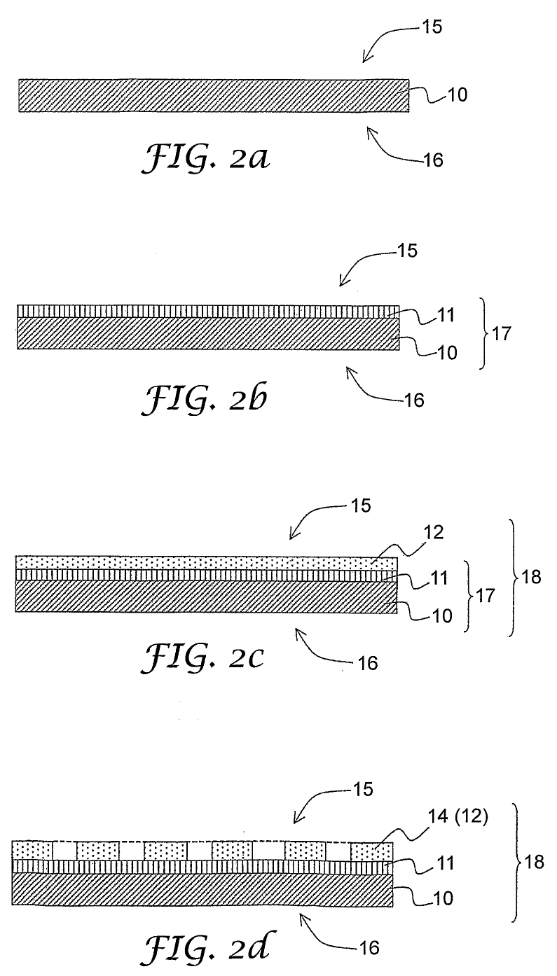

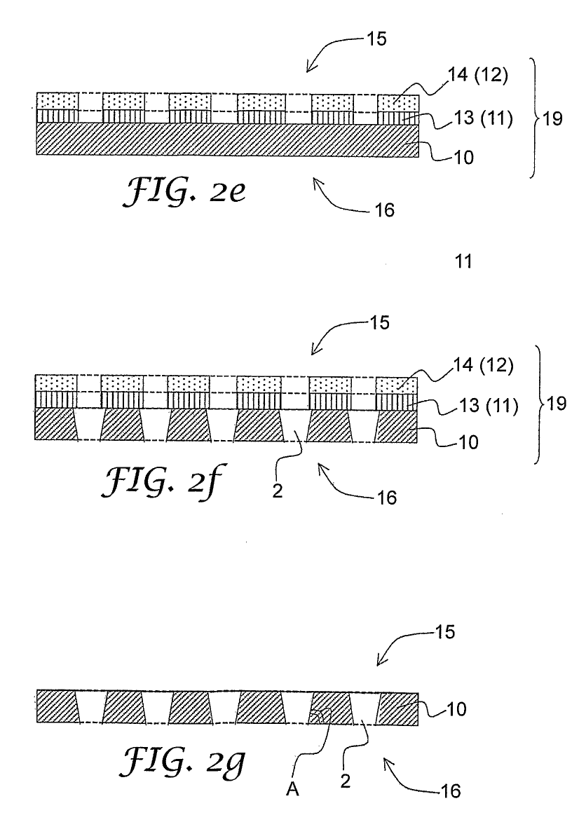

FIG. 1 is a plan view showing a substrate for a flexible printed circuit board 1 having via holes. FIGS. 2(a) to 2(g) are explanatory views each schematically showing a part of an embodiment of a method for forming a via hole in a substrate for a flexible printed circuit board of the present invention. As shown in FIG. 1, in a method for forming a via hole in a substrate for a flexible printed circuit board of the present embodiment, a via hole 2 is formed in a polymer-containing sheet-shaped substrate 10 for a flexible printed circuit so that the via hole 2 extends in a thickness direction of the substrate 10 for a flexible printed circuit board. Here, examples of the polymer include polyimide and polyester, and polyimide is preferable. To be concrete, as shown in FIGS. 2(a) and 2(b), the first thin film layer 11 containing metal or alloy and having a thickness of less than 2 μm is formed on one surface 15 of the substrate 10 for a flexible printed circuit board to obtain a substrate 17 with the first thin film layer; as shown in FIG. 2(c), the second thin film layer 12 containing a photosetting or thermosetting resin is disposed in such a manner that it covers the first thin film layer 11 of the obtained substrate 17 with the first thin film layer to obtain a substrate 18 with the second thin film layer; as shown in FIG. 2(d), a portion, corresponding to a region where a via hole 2 (see FIG. 1) is formed, of the second thin film layer 12 is selectively removed to make the second thin film layer 12 the second resist mask 14; as shown in FIG. 2(e), the first thin film layer 11 is subjected to etching through the second resist mask 14 to make the first thin film layer 11 the first resist mask 13 to obtain a substrate 19 with resist masks, i.e., a substrate 10 for a flexible printed circuit board with the first and the second resist masks 13, 14 disposed thereon; and, as shown in FIG. 2(f), a substrate 10 for a flexible printed circuit board 10 of the substrate 19 with resist masks is subjected to chemical milling to form a via hole 2 extending in a thickness direction of a substrate to second surface 16 for a flexible printed circuit board. FIG. 2(g) shows a substrate 10 for a flexible printed circuit board where the first and the second resist masks 13, 14 are removed.

When a via hole is formed in a substrate for a flexible printed circuit board, a resist mask has conventionally been formed using a copper thin film having a thickness of about 8 μm or more. However, in a method for forming a via hole in a substrate for a flexible printed circuit board of the present embodiment, as shown in FIG. 2(a) to FIG. 2(g), the first and the second resist masks 13, 14 are formed using the first thin film layer 11 containing metal or alloy, having a thickness of less than 2 μm, and being formed on one surface 15 of the substrate 10 for a flexible printed circuit board, and the second thin film layer 12 disposed in such a manner that it covers the first thin film layer 11, and the substrate 10 for a flexible printed circuit board is subjected to chemical milling.

A conventional method for forming a via hole in a substrate for a flexible printed circuit board has a problem of having a via hole with an oval opening portion since a resist mask formed of a copper leaf having a thickness of about 8 to 18 μm is used as described above. According to a method for forming a via hole in a substrate for a flexible printed circuit board of the present embodiment, a via hole having an excellent circularness of an opening portion and high reliability can simply be formed.

It is presumed that a conventional method for forming a via hole for a substrate for a flexible printed circuit board provides a via hole having an oval opening portion because high rigidity of the resist mask inhibits a chemical liquid entering from the resist mask from flowing favorably. Since the first thin film layer 11 having a thickness of less than 2 μm is used as the first resist mask 13 in a method for forming a via hole for a substrate for a flexible printed circuit board of the present embodiment, as shown in FIGS. 2(f) and 2(g), a chemical liquid entering from the first resist mask 13 flows favorably because of low rigidity of the first resist mask 13 when the substrate 10 for a flexible printed circuit board is subjected to chemical milling, and thereby imparting excellent circularness to an opening portion of a via hole 2.

Incidentally, “circularness” is an index showing a deviation of a shape of a formed opening portion from a complete round, and a shape of an opening having the smaller difference between the maximum diameter and the minimum diameter is closer to a complete round. To be specific, circularness can be obtained as follows:

circularness (%)=(maximum diameter−minimum diameter)/(average diameter)×100

In the case of a completely round opening, its circularness is 0% since the maximum diameter equals the minimum diameter. A via hole formed in a method for forming a via hole in a substrate for a flexible printed circuit board of the present embodiment preferably has a circularness of 6% or less.

In addition, in a method for forming a via hole in a substrate for a flexible printed circuit board of the present embodiment, a via hole 2 having an angle of a sloped side face of a via hole with one surface 16 of a substrate 10 for a flexible printed circuit board in FIG. 2(g) (hereinbelow referred to as “slope angle A”) of 35 to 40 degrees may be formed. For example, in the case of using a resist mask formed of only a thin film of a resin or the like in place of a resist mask of a thin film containing metal or alloy, a slope angle of a via hole is lowered to about 32 degree, and the via hole has a wider opening portion though the via hole can have an opening having an improved circularness. Since a plurality of via holes are formed, in the case of melting solder balls mounted in the via holes each having a widened opening portion, adjacent solder balls contact each other to cause a wiring defect. In addition, in the case of reducing a ball pitch of the solder balls, a contact area cannot be obtained, which causes difficulty in connection.

A method for forming a via hole in a substrate for a flexible printed circuit board of an embodiment of the present invention is more concretely described by each of the steps shown in FIGS. 2(a) to 2(g).

First, as shown in FIGS. 2(a) and 2(b), the first thin film layer 11 containing metal or alloy and having a thickness of less than 2 μm is formed on one surface 15 of a substrate 10 for a flexible printed circuit board to obtain a substrate 17 with the first thin film layer. The substrate 10 for a flexible printed circuit board is a polymer-containing sheet-shaped substrate, and a conventionally known substrate for a flexible printed circuit board may suitably be used. Particularly, as a substrate for a flexible printed circuit board capable of being suitably used for a method for forming a via hole in a substrate for a flexible printed circuit board of the present embodiment, there may be employed a substrate capable of being subjected to chemical milling, for example, a substrate constituted by a polymer obtained by synthesizing pyromellitic dianhydride (PMDA) and oxydianiline (ODA). Examples of the substrate include Kapton Polyimide Film produced by Du Pont and Apical Polyimide Film produced by Kaneka.

Incidentally, in a method for forming a via hole in a substrate for a flexible printed circuit board of the present embodiment, the first thin film layer 11 containing metal or alloy and formed on one surface 15 of the substrate 10 for a flexible printed circuit board has a thickness of preferably 1.5 μm or less, more preferably 1.0 μm or less though the thickness is not particularly limited. By such a constitution, a via hole having excellent circularness of an opening portion and high reliability may be formed.

Though there is no limitation with regard to a thickness of a substrate 10 for a flexible printed circuit board, a generally employed substrate for a flexible printed circuit board has a thickness of generally 7 to 200 μm.

In a method for forming a via hole in a substrate for a flexible printed circuit board of the present embodiment, one surface 15, where the first thin film layer 11 is formed, of a substrate 10 for a flexible printed circuit board is a surface opposite to the surface (the other surface 16) where a circuit is formed on a flexible printed circuit board 1 (see FIG. 1).

There is no particular limitation to a method for forming the first thin film layer 11 as long as a thin film having a thickness of less than 2 μm can be formed by the method, and suitable examples of the method include plating, chemical vapor deposition, printing, and sputtering. These methods enable to form a thin film having uniform thickness and to control thickness of the thin film with high accuracy.

In a method for forming a via hole in a substrate for a flexible printed circuit board of the present embodiment, there is no particular limitation to a material, or the like, of the first thin film layer 11 formed on one surface 15 of a substrate 10 for a flexible printed circuit board as long as the thin film contains metal or alloy and has a thickness of less than 2 μm. However, in the case that the first thin film layer 11 contains metal, it is preferable that the metal contained in the first thin film layer 11 is at least one selected from the group consisting of copper, aluminum, nickel, chromium, tin, and zinc. In the case that the first thin film layer 11 contains alloy, it is preferable that the alloy contained in the first thin film layer 11 is alloy containing, as the main component, at least one selected from the group consisting of copper, aluminum, nickel, chromium, tin, and zinc. These metals and alloys are inexpensive, can easily be obtained, and make formation of the thin film simple.

Next, as shown in FIG. 2(c), the second thin film layer 12 containing a photosetting or thermosetting resin is disposed so that it covers the first thin film layer 11 of the substrate 17 with the first thin film layer to obtain a substrate 18 with the second thin film layer. The second thin film layer 12 is for forming the second resist mask 14 (see FIG. 2(d)) to subject the first thin film layer 11 to etching.

There is no particular limitation to a method of disposing the second thin film layer 12. A thin film such as a conventionally known photosensitive dry film may be disposed so as to cover the first thin film layer 11, or the second thin film layer 12 may be disposed by a method such as printing and photolithographing using a photosensitive dry film or a photosensitive liquid resist.

The second thin film layer 12 contains a photosetting or thermosetting resin. For example, acrylic resin, epoxy resin, or the like, may suitably be used. There is no limitation to a thickness of the second thin film layer 12, and it is, for example, 1 to 50 μm.

Next, as shown in FIG. 2(d), in a substrate 18 with the second thin film layer, a portion, corresponding to a region where a via hole 2 (see FIG. 1) is formed, of the second thin film layer 12 is selectively removed to make the second thin film layer 12 the second resist mask 14; and as shown in FIG. 2(e), the first thin film layer 11 is subjected to etching through the second resist mask 14 to make the first thin film layer 11 the first resist mask 13 to obtain a substrate 19 with resist masks, i.e., a substrate 10 for a flexible printed circuit board with the first and second resist masks 13, 14 disposed thereon.

A method for making the second thin film layer 12 the second resist mask 14 shown in FIG. 2(d) may be realized by conventionally known photolithography or the like. Alternatively, a laser beam is irradiated to a predetermined portion (portion corresponding to a region where a via hole 2 (see FIG. 1) is formed) of the second thin film layer 12 containing a photosetting resin to expose the second thin film layer 12.

In addition, etching shown in FIG. 2(e) can be realized in accordance with a conventional known etching. Since the first thin film layer 11 containing metal or alloy is subjected to etching in FIG. 2(e), an acid etching liquid such as copper chloride solution, iron chloride solution, or hydrogen peroxide/sulfuric acid is employed.

Next, as shown in FIGS. 2(f) and 2(g), a substrate 10 for a flexible printed circuit board of the obtained base 19 with resist masks is subjected to chemical milling to form via holes extending in a thickness direction of the substrate 10 for a flexible printed circuit board. As for chemical milling of the substrate 10 for a flexible printed circuit board, since a polymer-containing substrate 10 for flexible printed circuit board is subjected to chemical milling, chemical liquid such as alkali solution and hydrazine solution is used. Time spent for chemical milling may suitably be determined depending on a thickness of the substrate 10 for a flexible printed circuit board and the size of via holes 2 to be formed. After via holes 2 are formed in such a manner, the first and second resist masks 13, 14 are removed.

As described above, according to a method for forming a via hole in a substrate for a flexible printed circuit board of the present embodiment, a via hole having an excellent circularness of an opening portion and high reliability can be formed simply.

In addition, in a method for forming a via hole in a substrate for a flexible printed circuit board, it is preferable to form a circuit constituted by a conductive material on the other surface of the substrate for a flexible printed circuit board in parallel with the formation of via holes. For example, a circuit for a flexible printed circuit board can be formed by applying a thin film-shaped conductive material on the other surface of the substrate for a flexible printed circuit board and subjecting the thin film-shaped conductive material to etching so as to obtain a circuit having a predetermined shape. In a method for forming a via hole in a substrate for a flexible printed circuit board of the present embodiment shown in FIGS. 2(a) to 2(g), steps for etching, etc., can be conducted simultaneously with the formation of the circuit, and thereby simplification of steps can be realized.

Concrete description will hereinbelow be made on a method for forming a via hole simultaneously with the formation of the circuit for a flexible printed circuit board on the other surface of the substrate for a flexible printed circuit board in the present embodiment.

First, simultaneously with forming the first thin film layer containing metal or alloy and having a thickness of less than 2 μm on one surface of a substrate for a flexible printed circuit board, a conductive metallic thin film for forming a circuit on a substrate for a flexible printed circuit board is disposed on the other surface to obtain a metallized substrate with a first thin film mask layer. The metallic thin film can be disposed by, for example, plating copper or the like. Though there is no particular limitation to a thickness of the metallic thin film, it is, for example, 2 to 50 μm.

Next, when the second thin film layer is disposed so that it covers the first thin film layer to obtain a substrate with the second thin film layer, a resin thin film containing a photosetting or thermosetting resin can be disposed on the metallic thin film disposed on the other surface. This resin thin film serves as a resist mask to obtain a circuit by subjecting the metallic thin film to etching, and a film constituted by a material similar to that of the second thin film layer may suitably be used.

Next, in the obtained substrate with the second thin film layer, a portion, corresponding to a region where a via hole is formed, of the second thin film layer is selectively removed to make the second thin layer the second resist mask, further, a region, corresponding to a region to have a circuit pattern on a flexible printed circuit board, of a resin thin film disposed on the other surface is selectively removed to make the resin thin film a resist mask for a circuit. Incidentally, though the second resist mask and the resist mask for a circuit may form at respective times, it is preferable to form them at the same time by photolithography from the viewpoint of simplification of the production process.

Next, in an additive process, plating is conducted on the other surface of the flexible printed circuit board. A protective film is disposed on the second resist mask before the plating so as to cover the second resist mask lest the plating should be exfoliated. It is possible to use a micro adhesive sheet having an adhesive on one surface as the protective sheet so that the protective sheet can be peeled off easily after the circuit is formed.

After the protective film is thus disposed, plating corresponding to a circuit pattern is conducted on the other surface side (the side of the resist mask for a circuit) to form a plating layer corresponding to a circuit pattern on a surface of the metallic thin film. A portion, where a plating layer is formed, of the metallic thin film finally serves as a circuit. The plating may be conducted according to a method conventionally performed when a circuit is formed on a substrate for a flexible printed circuit board. It is preferable that the plating is conducted with a metal of the same kinds as the metallic thin film. For example, in the case that copper is used for the metallic thin film, plating with copper is preferable.

Next, a protective film constituted by a material similar to that of the protective film is disposed so as to cover the second resist mask on the other surface side where plating has been conducted (the side of the resist mask for a circuit). This protective film is to inhibit the above plating for forming a circuit from exfoliating when the first thin film layer on one surface side is subjected to etching to make it the first resist mask.

Next, after the protective film on the second resist mask side is removed, the first thin film layer is subjected to etching through the second resist mask to make the first thin film layer the first resist mask to obtain a substrate with resist masks, i.e., a substrate for a flexible printed circuit board with the first and second resist masks disposed thereon. The etching of the first thin film layer can be conducted in a method similar to the method shown in FIG. 2(e).

Next, a base for a flexible printed circuit board of the obtained substrate with the resist masks is subjected to chemical milling to form a via hole extending in a thickness direction of the substrate for a flexible printed circuit board. The chemical milling of the substrate for a flexible printed circuit board can be conducted in the same method as shown in FIG. 2(f).

Next, the second resist mask on one surface side, the protective film on the other surface side (the side of the resist mask for a circuit), and the resist mask for a circuit are peeled out. Next, the metallic thin film and the plating layer are subjected to etching so that a portion, corresponding to a region where the plating layer is formed, of the metallic thin film remains as a circuit to form a circuit on the other surface of the substrate for a flexible printed circuit board. At this time, the first resist mask constituted by metal or alloy is also removed by etching. By this constitution, a circuit having a predetermined shape can be formed with via holes being formed in a substrate for a flexible printed circuit board.

When a circuit is formed as described above, it is preferable to plate the formed circuit with nickel or gold. Incidentally, etching in a method for forming a via hole in a substrate for a flexible printed circuit board of the present embodiment described above can be conducted in the same method as the etching method conducted in a conventional method for forming a via hole in a substrate for a flexible printed circuit board.

### EXAMPLES

The present invention is hereinbelow described more concretely by Examples. However, the present invention is by no means limited to these Examples.

### Example 1

A polyimide film having a thickness of 75 μm (product name: Apical NPI Film produced by Kaneka) was employed as a substrate for a flexible printed circuit board, and via holes were formed in the flexible printed circuit board.

In the present Example, in the first place, a copper thin film having a thickness of 1 μm was formed as the first thin film layer by plating on one surface of the substrate for a flexible printed circuit board, and a copper thin film having a thickness of 3 μm was formed as the metallic thin film for forming a circuit on the other surface. Next, a photosensitive dry film was disposed as the second thin film layer so as to cover the first thin film layer. A photosensitive dry film similar to the second thin film was disposed so as to cover the metallic thin film as a resin thin film to serve as a resist mask for a circuit.

Next, the pattern of the via holes was formed in the second thin film layer by photolithographing to make the second resist mask, and the pattern of the circuit was formed on the resin thin film to make a resist mask for the circuit. Next, a protective film was disposed on the second resist mask, and then the other surface was plated with copper to form a plating layer corresponding to a circuit pattern on the surface of the metallic thin film. Next, a protective film was disposed on the other surface side, and the protective film on the second resist mask side was peeled off. The first thin film layer was subjected to etching through the second resist mask to make the first thin film layer into the first resist mask. Next, the substrate for a flexible printed circuit board was subjected to chemical milling through the first and second resist masks to form via holes extending in a thickness direction of the substrate of a flexible printed circuit board. Finally, the second resist mask on one surface side and the protective film and the resist mask for a circuit on the other surface side (side of the resist mask for a circuit) were peeled off, the metallic thin film and the plating layer on the surface of the metallic thin film were subjected to etching so that a portion, corresponding to a region where the plating layer was formed, of the metallic thin film might remain to form a circuit on the other surface of the substrate for a flexible printed circuit board.

Via holes formed by the present Example each had an excellent circularness of an opening portion and high reliability. In addition, they had a slope angle of 40 degrees, and adjacent solder balls did not contact each other at all when the solder balls were melted.

### Comparative Example 1

Via holes were formed in the same manner as in Example 1 except that the substrate for a flexible printed circuit board was plated with a copper thin film having a thickness of 2 μm as the first thin film layer. The via holes formed in Comparative Example 1 each had an oval opening portion and was impossible to be used as a via hole.

### Comparative Example 2

Via holes were formed in the substrate for a flexible printed circuit board by subjecting the substrate for a flexible printed circuit board to chemical milling by the second resist mask using only the second thin film layer without forming a copper thin film as the first thin film layer. The via holes formed in Comparative Example 2 have an opening portion having nearly circular relatively and were possible to be used as via holes. However, the via holes have a slope angles of 32 degrees, and when solder balls were melted, about 1% of the adjacent solder balls contact each other with respect to the total number of via holes formed, which caused a wiring defect.

### Example 2

Via holes were formed with providing the first thin film layer having a thickness of 1 μm in the same manner as in Example 1. In the present Example, 289 via holes were formed in the substrate for a flexible printed circuit board having the size of 10 mm×10 mm. The distance between the centers of mutually adjacent two via holes was about 0.5 mm. An image of the substrate for a flexible printed circuit board having via holes formed therein was taken in with no contact using a three-dimensional measuring device (product name: Quick Vision QV404) produced by Mitutoyo Corporation. Among the via holes to be measured, 10 via holes (via holes 1 to 10) were selected at random, and each of the 10 via holes was measured for average diameter and difference between the maximum diameter and the minimum diameter for calculation by the three-dimensional measuring device. On the base of the calculation, circularness of each via hole was calculated. Table 1 shows each value of the 10 via holes. All the 10 via holes had a circularness of 6% or less.

TABLE 1

| | Via hole | | | | | | | | | |
|---|---|---|---|---|---|---|---|---|---|---|
| | 1 | 2 | 3 | 4 | 5 | 6 | 7 | 8 | 9 | 10 |
| Average diameter (mm) | 0.201 | 0.207 | 0.205 | 0.200 | 0.199 | 0.204 | 0.203 | 0.200 | 0.201 | 0.203 |
| Difference between | 0.004 | 0.007 | 0.005 | 0.006 | 0.009 | 0.006 | 0.006 | 0.005 | 0.005 | 0.008 |
| maximum diameter & | | | | | | | | | | |
| minimum diameter (mm) | | | | | | | | | | |
| Circularness (%) | 2.042 | 3.437 | 2.445 | 2.957 | 4.468 | 2.888 | 2.863 | 2.597 | 2.443 | 3.696 |

### Comparative Example 3

Via holes were formed with providing the first thin film layer having a thickness of 2 μm in the same manner as in Comparative Example 1. In the present Comparative Example, 289 via holes were formed in the substrate for a flexible printed circuit board having the size of 10 mm×10 mm. The distance between the centers of mutually adjacent two via holes was about 0.5 mm. An image of the substrate for a flexible printed circuit board having via holes formed therein was taken in with no contact using a three-dimensional measuring device used in Example 2. Among the via holes to be measured, 10 via holes (via holes 1 to 10) were selected at random, and each of the 10 via holes was measured for average diameter and difference between the maximum diameter and the minimum diameter for calculation by the three-dimensional measuring device. On the base of the calculation, circularness of the each via hole was calculated. Table 2 shows each value of the 10 via holes. All the 10 via holes had a circularness of above 6%.

TABLE 2

| | Via hole | | | | | | | | | |
|---|---|---|---|---|---|---|---|---|---|---|
| | 1 | 2 | 3 | 4 | 5 | 6 | 7 | 8 | 9 | 10 |
| Average diameter (mm) | 0.208 | 0.207 | 0.229 | 0.210 | 0.208 | 0.205 | 0.204 | 0.172 | 0.197 | 0.207 |
| Difference between | 0.043 | 0.041 | 0.016 | 0.023 | 0.028 | 0.027 | 0.033 | 0.041 | 0.047 | 0.053 |
| maximum diameter & | | | | | | | | | | |
| minimum diameter (mm) | | | | | | | | | | |
| Circularness (%) | 20.47 | 19.54 | 6.818 | 10.98 | 13.53 | 13.15 | 16.14 | 23.65 | 23.92 | 25.57 |

### Comparative Example 4

Via holes were formed without providing the first thin film layer in the same manner as in Comparative Example 2. Via holes were formed with providing the first thin film layer having a thickness of 2 μm in the same manner as in Comparative Example 1. In the present Comparative Example, 289 via holes were formed in the substrate for a flexible printed circuit board having the size of 10 mm×10 mm. The distance between the centers of mutually adjacent two via holes was about 0.5 mm. An image of the substrate for a flexible printed circuit board having via holes formed therein was taken in with no contact using a three-dimensional measuring device used in Example 2. Among the via holes to be measured, 10 via holes (via holes 1 to 10) were selected at random, and each of the 10 via holes was measured for average diameter and difference between the maximum diameter and the minimum diameter for calculation by the three-dimensional measuring device. On the base of the calculation, circularness of the each via hole was calculated. Table 3 shows each value of the 10 via holes. All the 10 via holes had a circularness of 6% or less.

TABLE 3

| | Via hole | | | | | | | | | |
|---|---|---|---|---|---|---|---|---|---|---|
| | 1 | 2 | 3 | 4 | 5 | 6 | 7 | 8 | 9 | 10 |
| Average diameter (mm) | 0.176 | 0.181 | 0.178 | 0.178 | 0.178 | 0.178 | 0.181 | 0.182 | 0.181 | 0.181 |
| Difference between | 0.004 | 0.004 | 0.004 | 0.004 | 0.003 | 0.003 | 0.003 | 0.004 | 0.004 | 0.003 |
| maximum diameter & | | | | | | | | | | |
| minimum diameter (mm) | | | | | | | | | | |
| Circularness (%) | 2.106 | 2.044 | 2.357 | 2.141 | 1.458 | 1.741 | 1.715 | 2.255 | 2.210 | 1.661 |

### INDUSTRIAL APPLICABILITY

According to a method for forming a via hole in a substrate for a flexible printed circuit board of the present invention, a via hole having an excellent circularness of an opening portion and high reliability can simply be formed in a substrate for a flexible printed circuit board capable of high density mounting of electronic parts.

1. A method for forming a via hole in a polymer-containing sheet-shaped substrate for a flexible printed circuit board, the via hole extending in a thickness direction of the substrate for the flexible printed circuit board, wherein the method comprises:
forming a first thin film layer containing metal or alloy and having a thickness of less than 2 μm on one surface of the substrate for the flexible printed circuit board to obtain a substrate with the first thin film layer,
disposing a second thin film layer containing a photosetting or thermosetting resin in such a manner that it covers the first thin film layer to obtain a substrate with the first film layer and the second thin film layer,
selectively removing the second thin film layer from a portion corresponding to a region where the via hole is to be formed to make the second thin film layer a second resist mask,
etching the portions of the first thin film layer exposed by the second resist mask to make the first thin film layer a first resist mask to obtain a substrate with the resist masks where the first and the second resist masks are disposed on the substrate for the flexible printed circuit board, and
subjecting the substrate with the resist masks to chemical milling to form the via hole extending in a thickness direction of the substrate for the flexible printed circuit board.

2. A method for forming a via hole in a substrate for a flexible printed circuit board according to claim 1, wherein a circuit of a conductive material is formed on the second surface of the substrate for the flexible printed circuit board.

3. A method for forming a via hole in a substrate for a flexible printed circuit board according to claim 1, wherein the side face of the via hole has a slope angle of 35 to 40°.

4. A method for forming a via hole in a substrate for a flexible printed circuit board according to claim 1, wherein the first film layer contains a metal selected from the group consisting of copper, aluminum, nickel, chromium, tin, zinc and alloys thereof.
